(19) United States
(12) Patent Application Publication
(10) Pub. No.: US 2012/0087588 A1
(43) Pub. Date: Apr. 12, 2012

(54) SYSTEM AND METHOD FOR CUSTOMIZED VIEWING OF VISUAL MEDIA

(76) Inventor: Gerald Carter, Christchurch (NZ)

(21) Appl. No.: 12/901,192

(22) Filed: Oct. 8, 2010

(51) Int. Cl. G06K 9/46

(52) U.S. Cl. 382/190

(57) ABSTRACT

The customized viewing of an event, such as a sports event, includes identifying an object in the sports event with an identification device, capturing visual media such as photograph(s) or video of said sports event and marking the visual media upon the recognition of the object by a camera. The captured visual media is encoded into a variety of display formats for easy viewing on any selected display device. Electronic information tags include real-time and/or historical information specific for the object and is stored on a database and linked with a unique identification used to identify the object. A user selects items such as object(s) and tag(s) from selection matrixes for the captured visual media and produces a filtered visual media that is customized to the viewing desires of that user.

### PRIORITY AND RELATED APPLICATION

N/A

### FIELD OF THE INVENTION

The present invention relates to customized viewing of contemporaneous visual media of a sporting event. More specifically, the present invention relates to viewing contemporaneous sporting video or photographs based on selection of information of objects within the video or photographs of the sporting event.

### BACKGROUND OF THE INVENTION

There is an immeasurable difference in watching sporting events at home as opposed to live in the sporting arena. Live sporting events allows fans greater freedom to watch the sport at their own pace, focus in on particular athletes or an area of the sporting field. Such freedom is greatly curtailed when viewing the same event remotely such as at home. Normally these at-home viewers must rely on the perception of a sports commentator to fully comprehend the particulars of a game and the camera view or angle selected by the broadcasting network on which the sporting event is being viewed. For instance in a bike race, viewers are led by the sports commentator hired by the broadcast network in viewing and comprehending the actions of the race. Not only is great liberty usurped from the viewer when viewing a particular contestant at their pleasure, but great burden is placed on the network broadcasting the event to capture the heat of the action.

A need exists to enhance the viewing experience of the at-home sports fan who is unable to attend a live sporting event. There is a need to permit a viewer to manipulate the viewing of the sporting event based on factors related to the sporting event such as focusing on a particular team, an athlete within the sporting event or a sports object (ball or hockey puck) that is being used in the play of the sports event. A need also exists to provide the viewer with an enhanced viewing experience by providing information on the object of interest such as historical information, biometric information or even physiological information.

### BRIEF SUMMARY OF THE INVENTION

A customized viewing experience of an event comprises identifying at least one object in said event with an electronic identification, recording and marking the visual media of said event, storing electronic information tags about objects displayed in the visual media in a computerized database, and associating the electronic information tag with the electronic identification marked on the visual media. The visual media is encoded in a variety of formats for viewing on any display device. In one embodiment the event that is described herein is a sporting event and the object in the event may be an athlete, a race animal, a sporting team or sporting equipment such as a ball or a hockey puck. In one embodiment the visual media may be a video or several photographs of the sporting event. The stored electronic tag information includes both historical information on the object as well as real-time information on the object that is captured during the sporting event. The visual media can be filtered by selecting any combination of information within the tag for the selected object. The filtered media may be viewed by a user on a display device.

### BRIEF DESCRIPTION OF THE DRAWING

FIG. 1 is a flowchart detailing the steps of capturing, encoding, saving, tagging and viewing visual media in accordance with the present invention.

### DETAILED DESCRIPTION OF THE INVENTION

The creation of a customized viewing experience of the present invention provides a user with the ability to view customized or filtered visual media that provides both real-time imaging and real-time and historical information of a selected object of interest. The present invention will be described with regard to capturing media of a contemporaneous sporting event such as a race including a relay race, a marathon, a boat race, a horse race, etc. In some embodiments, the contemporaneous, real-time event could be a conference, a musical concert, or other event with more than one participant. In another alternative embodiment, the sporting event may be a game having a moving play object including a ball, puck, etc. used in football, soccer, cricket, hockey, etc. In yet another embodiment, the event may be already captured and exist as a pre-existing or previously recorded video.

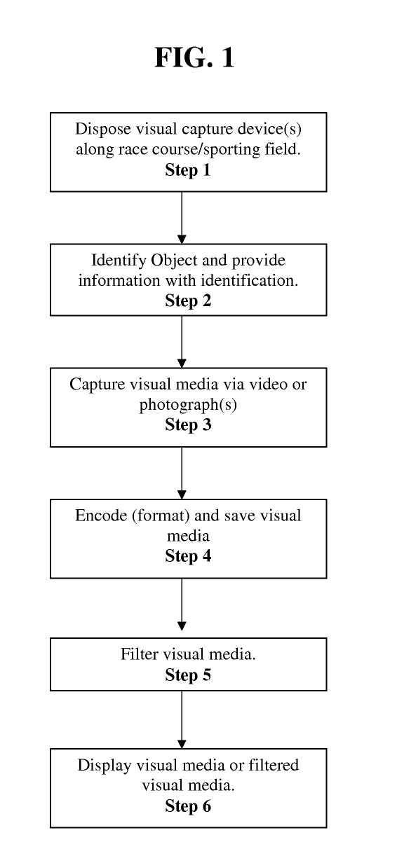

Referring now to FIG. 1, visual capture devices such as video cameras or still cameras fitted with a sensor will be placed along the game course or race course to capture a sporting event, step 1. Each competitor or object is also fitted with a unique electronic identification device for identification purposes, step 2. In the case where the object is a moving object such as a soccer ball, the ball is fitted with a unique electronic identification device and the sensors are placed in the goal post, sports field boundary, or any other location, as well as the visual capture device(s). It should be noted that steps one and two may be performed in reverse order. The unique electronic identification device disposed on the object provides a unique electronic identification via an RFID to which any information can be assigned thereto or a GPS device from which any information can be derived. In another embodiment the identification device may be a combined RFID and GPS device.

When the unique electronic identification is recognized by the sensor on said visual capture device, visual media is either marked or captured and associated with the unique electronic identification and stored on a computer database. For instance, when the sensor in a still camera recognizes the unique electronic identification device on the object, the camera is activated to take a picture or a series of photographs for a pre-selected period of time and the unique electronic identification is associated therewith. When the unique electronic identification device on the object is recognized by the sensor on a video camera a pre-selected length of the continuous real-time video is marked and associated with the unique electronic identification. Step 3.

The marked and captured media stored on the computer database is linked with at least one electronic information tag concerning the object. The tags employed in the present invention provide historical and/or real-time information on the object and can be stored on a computer database. Historical information may be provided prior to or contemporaneous with the event while real-time information can be captured during the sporting event and may be derived from the unique electronic identification devices. For instance, an RFID device may be linked with historical information such as the dates on which an object such as a marathoner last won a race, the fastest running time ever achieved by that marathoner, etc. The RFID may also provide statistics on an athlete such as age, weight, height, etc. Other information that may be provided with the tags on the object of desire includes the competitor's name, team names, statistics on the competitor, statistics on a team, etc.

The real-time information tags provided for an object such as an athlete includes information that can be derived from a unique electronic identification device such as identifying the fastest or slowest competitor or speed and pace of an object. For example real-time information can be gathered on whether the ball or object has passed a given point such as a goal post, score line, etc. Biometric and physiological information may also be derived from specifically designed unique electronic identification devices for information such as heart rate, respiration rate, body temperature, drugs used by the competitor, hydration levels, etc. In one embodiment, real-time speed information for a marathoner may be calculated during any portion of the race using computer software disposed on computer readable medium that processes time stamps provided at select portions of the captured visual media. In another embodiment, real-time speed information can be calculated for a soccer ball that travels from one area on a sports field to another area based on the distance traveled as calculated on the video captured media or based on the distance traveled as calculated between sensors placed on a play field. Other real-time information that may be available for objects include manufacturing details, location of object, etc.

The captured and stored visual media is encoded, or changed in format, in different display formats. See step 4. For instance, the individual viewing mode may be formatted for viewing over the internet, on a cell phone, smart phone, lap top, computer, iPad or any other mobile device capable of receiving said information. The encoded media may be viewed in its original state, as continuous video or series of photographs, or may be user customized and viewed as filtered visual media. See step 5.

Filtered visual media is realized by providing a user with a selection matrix and allowing the user to select items of interest to them from the selection matrix over a computerized system. The selection matrix includes an objects matrix which includes a list of objects as displayed on the media of the sporting event and an electronic information tag matrix that includes a list of tags about the objects in the media. Both the information tag matrix and the matrix of objects are stored on a computerized system that is accessible to the user.

An example of customizing or filtering media can be shown in the following example. Take for instance a user interested in viewing a live broadcast of the Tour de France, the user can choose to focus the visual media on Lance Armstrong, the US team and/or anyone who just crashed. The variations available for viewing one recording of an event are limitless.

In another embodiment, a user is provided with the ability to view pre-filtered or pre-selected visual media. The visual media in the pre-selected matrix provides a user with visual media similar to that shown by sports broadcast networks. For instance, the pre-filtered visual media may be a pre-arranged video of an entire race or football game showing the actions of a single competitor or team or actions occurring only at a particular area of a field. The pre-filtered media thus shows real-time visual media filtered with prescribed criteria as selected by a third party.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A method for customized viewing of visual media comprising:
identifying at least one object involved in a sporting event using electronic identification, said electronic identification being specific to the object;
capturing real-time visual media of the sporting event using at least one visual capture device, wherein the visual capture device has a sensor for recognizing said electronic identification;
marking said captured real-time visual media with the electronic identification recognized by said visual capture device;
storing said captured real-time visual media on a computer database;
storing electronic information tags about the object on said computer database, said electronic information tags being stored on said computer database along with the electronic identification;
encoding said stored real-time visual media into a variety of display formats;
providing selection matrixes for said encoded and stored real-time visual media, wherein said selection matrixes includes a list of said objects involved in said sporting event and a list of said information tags;
filtering said real-time visual media by selecting at least one item from said selection matrixes; and
displaying said filtered real-time visual media on a display device.

2. The method of claim 1, wherein said selection matrixes includes a pre-filtered matrix listing said real-time video using prescribed criteria.

3. The method of claim 1, wherein said electronic information tags provide historical information on said object.

4. The method of claim 1, wherein said electronic information tags provide real-time information on said object.

5. The method of claim 4, wherein said real-time visual media is continuous and contemporaneous video of the sporting event.

6. The method of claim 1, wherein real-time visual media is at least one photograph of the sporting event.

7. The method of claim 1, wherein the display device includes a cell phone, a laptop, a computer and an ipad.

8. The method of claim 1, wherein said object includes an athlete, a race animal and a moving play item.

9. A system for customized viewing of visual media comprising:
an electronic identification device disposed on an object involved in a sporting event, said electronic identification device having an electronic identification specific for the object on which the device is disposed;
at least one visual capture device, said visual capture device capturing continuous and contemporaneous visual media of said sporting event, said visual capture device having a sensor, said sensor recognizing said electronic identification of said object and marking the visual media with said electronic identification upon recognition of the electronic identification, wherein said marked visual media is stored on a computer database;
at least one electronic information tag, said electronic information tag being stored with said marked visual media on said computer database, said electronic information tag having information specific for said object that is selected;
an encoding device, said encoding device formatting said visual media into a variety of display formats;
at least one selection matrix for said visual media, said selection matrix including an object matrix and an electronic information tag matrix, wherein said object matrix provides a list of said objects involved in said sporting event and said tag matrix provides a list of said electronic information tags specific for said object that is selected;
an electronic filter, said filter capable of producing a filtered and encoded visual media, wherein said filtered and encoded visual media is realized by selecting at least one item from said selection matrix over a computerized system; and
a display, said display being used to view said filtered and encoded visual media.

10. The system of claim 9, wherein the filtered visual media is a customized video displaying a portion of said visual media that contains said at least one tag and said at least one object selected by said user.

11. The system of claim 9, wherein the electronic information tag is a meta tag.

12. The system of claim 9, wherein the electronic information tag provides real-time information about an object including medical, physiological and biometric information.

13. The system of claim 9, wherein the electronic information tag provides real-time information including heart rate, body temperature, drugs used by a competitor, hydration levels.

14. The system of claim 9, wherein the electronic information tag provides real-time information including speed of said object, manufacturing details and location of said object.

15. The system of claim 9, wherein said visual media is encoded into a file format suitable for viewing on said display.

16. The system of claim 9, wherein said file format is compatible with viewing on computers.

17. The system of claim 9, wherein said file format is compatible with viewing on cell phones.

18. The system of claim 9, wherein said visual media is at least one real-time photograph of said event.

19. The system of claim 18, wherein said filtered and encoded visual media is a series of said real-time photographs of said event.
